(19) United States
(12) Patent Application Publication
(10) Pub. No.: US 2025/0269636 A1
(43) Pub. Date: Aug. 28, 2025

(54) METHOD OF MANUFACTURING GAS BARRIER FILM PACKAGING MATERIAL

(71) Applicant: FUJIFILM Corporation, Tokyo (JP)

(72) Inventors: Tomokazu SEKI, Minamiashigara-shi (JP); Eijiro IWASE, Minamiashigara-shi (JP)

(73) Assignee: FUJIFILM Corporation, Tokyo (JP)

(21) Appl. No.: 19/193,628

(22) Filed: Apr. 29, 2025

Related U.S. Application Data
(63) Continuation of application No. PCT/JP2023/041967, filed on Nov. 22, 2023.

(30) Foreign Application Priority Data
Dec. 13, 2022 (JP) 2022-198405

(51) Int. Cl. B32B 37/12; B32B 7/12; B32B 27/08; B32B 27/32; B32B 27/36; B32B 38/00

(52) U.S. Cl. CPC B32B 37/12; B32B 7/12; B32B 27/08; B32B 27/32; B32B 27/36; B32B 38/0036; B32B 2037/1253; B32B 2307/7242; B32B 2307/7376; B32B 2439/46

(57) ABSTRACT

Provided is a method of manufacturing a gas barrier film packaging material having a sufficient adhesive strength between a thermal fusion layer and a gas barrier film. The method of manufacturing a gas barrier film packaging material, includes: a gas barrier film preparation step of forming, on a support, a gas barrier layer where laminated structures of an organic layer and an inorganic layer are provided and an upper most layer is an organic layer; a bonding step of applying an adhesive to the gas barrier layer to cover an entire surface of the support, drying the adhesive, and bonding a thermal fusion layer having a width more than or equal to a width of the support to the adhesive to obtain a gas barrier film packaging material; a winding step of winding the gas barrier film packaging material; and an aging step of heating and aging the gas barrier film packaging material, in which in the gas barrier film preparation step, a non-formation region where the laminated structure of the organic layer and the inorganic layer is not formed is provided in both end parts in a width direction.

### CROSS-REFERENCE TO RELATED APPLICATIONS

This application is a Continuation of PCT International Application No. PCT/JP2023/041967 filed on Nov. 22, 2023, which claims priority under 35 U.S.C. § 119(a) to Japanese Patent Application No. 2022-198405 filed on Dec. 13, 2022. The above applications are hereby expressly incorporated by reference, in their entirety, into the present application.

### BACKGROUND OF THE INVENTION

### 1. Field of the Invention

The present invention relates to a method of manufacturing a gas barrier film packaging material to be bonded to an infusion bag or the like for protecting the content.

### 2. Description of the Related Art

An infusion bag for accommodating a drug that is denatured by water or oxygen and a tube or a packaging bag for accommodating food that also deteriorates due to water or oxygen are required to have high gas barrier properties from the viewpoint of improving storage stability of a drug or the like.

In the infusion bag and the like, gas barrier properties are improved by bonding a gas barrier film to a surface.

As a gas barrier film having high gas barrier properties, there is known an organic-inorganic laminated gas barrier film where one or more combinations of inorganic layers that exhibit gas barrier properties and organic layers that are underlying layers of the inorganic layers are provided on a support such as a resin film.

JP2012-075716A describes an infusion bag to which this organic-inorganic laminated gas barrier film is bonded.

Specifically, JP2012-075716A discloses an infusion bag including: a bag consisting of a resin film including polyethylene and/or polypropylene; and a barrier layer provided on at least one surface of the bag, in which the barrier layer has a structure in which a first organic layer, an inorganic layer, and a second organic layer mutually adjoin in this order.

### SUMMARY OF THE INVENTION

In the infusion bag described in JP2012-075716A, as the gas barrier film where the barrier layer is provided on the support (plastic film), a thermal fusion layer consisting of the same resin film as that of the resin bag is bonded to the gas barrier film, and the thermal fusion layer is thermally fused to the resin bag to bond the gas barrier film to the infusion bag.

Specifically, in the infusion bag described in JP2012-075716A, a laminated film is prepared, the laminated film including the gas barrier film, an adhesive, and the thermal fusion layer, in which the thermal fusion layer adheres to the second organic layer of the gas barrier film through the adhesive. By thermally fusing the thermal fusion layer of the laminated film to the resin bag, the gas barrier film is bonded to the infusion bag.

Incidentally, according to an investigation by the present inventors, in the laminated film where the thermal fusion layer is bonded to the gas barrier film using the adhesive, an adhesive strength of the adhesive may be insufficient depending on the manufacturing method, and the thermal fusion layer and the gas barrier film may be peeled off.

In particular, in a case where the gas barrier performance of the gas barrier film is high, the adhesive strength of the adhesive is likely to be insufficient depending on the manufacturing method, and the thermal fusion layer and the gas barrier film are likely to be peeled off.

An object of the present invention is to provide a method of manufacturing a gas barrier film packaging material having a sufficient adhesive strength between a thermal fusion layer and a gas barrier film in the gas barrier film packaging material that includes the gas barrier film and the thermal fusion layer and is thermally fused to an infusion bag or the like for preventing the content from deteriorating due to water or the like.

In order to achieve the object, the present invention has the following configurations.

[1] A method of manufacturing a gas barrier film packaging material, comprising:
a gas barrier film preparation step of forming, on a support, a gas barrier layer where one or more laminated structures of an underlying organic layer and an inorganic layer are provided and an upper most layer is a protective organic layer to prepare a gas barrier film;
a bonding step of applying an adhesive to the gas barrier layer of the gas barrier film to cover an entire surface of the support, drying the adhesive, and bonding a thermal fusion layer having a width more than or equal to a width of the support to the adhesive to obtain a gas barrier film packaging material;
a winding step of winding the gas barrier film packaging material; and
an aging step of heating and aging the wound gas barrier film packaging material,
in which in the gas barrier film preparation step, a non-formation region where the laminated structure of the underlying organic layer and the inorganic layer and the protective organic layer are not formed is provided in both end parts in a width direction of the support.

[2] The method of manufacturing a gas barrier film packaging material according to [1]
in which in the gas barrier film preparation step, the inorganic layer is formed in the non-formation region.

[3] The method of manufacturing a gas barrier film packaging material according to [1] or [2],
in which in the aging step, a heating temperature is 30° C. to 50° C., and an aging time is 48 hours or longer.

[4] The method of manufacturing a gas barrier film packaging material according to any one of [1] to [3],
in which a winding tension of the gas barrier film packaging material in the winding step is 10 to 200 N.

[5] The method of manufacturing a gas barrier film packaging material according to any one of [1] to [4],
in which in the gas barrier film, a gas barrier performance in the non-formation region is lower than a gas barrier performance in a center portion in the width direction of the support.

[6] The method of manufacturing a gas barrier film packaging material according to [5],
in which a water vapor transmission rate in the center portion of the gas barrier film in the width direction of the support is 1.0×10⁻⁴ g/(m²·day) or less in an environment of a temperature of 25° C. and a relative humidity of 50%, and
a water vapor transmission rate in the non-formation region of the gas barrier film is 1.0×10⁻¹ g/(m²·day) or more in the environment of a temperature of 25° C. and a relative humidity of 50%.

[7] The method of manufacturing a gas barrier film packaging material according to any one of [1] to [6],
in which in a gas barrier film packaging material to be manufactured, a gas barrier performance in a region corresponding to the non-formation region of the gas barrier film is lower than a gas barrier performance in a region corresponding to a center portion of the gas barrier film in the width direction of the support.

[8] The method of manufacturing a gas barrier film packaging material according to [7],
in which in the gas barrier film packaging material to be manufactured, a water vapor transmission rate at a position corresponding to the center portion of the gas barrier film in the width direction of the support is 1.0×10⁻⁴ g/(m²·day) or less in an environment of a temperature of 25° C. and a relative humidity of 50%, and
a water vapor transmission rate in a region corresponding to the non-formation region of the gas barrier film is 1.0×10⁻¹ g/(m²·day) or more in the environment of a temperature of 25° C. and a relative humidity of 50%.

[9] The method of manufacturing a gas barrier film packaging material according to any one of [1] to [8],
in which the thermal fusion layer is formed of polyethylene or polypropylene.

The method of manufacturing a gas barrier film packaging material according to any one of [1] to [9],
in which a thickness of the thermal fusion layer is 30 to 70 μm.

The method of manufacturing a gas barrier film packaging material according to any one of [1] to [10],
in which a thickness of the support is 50 to 125 μm.

The method of manufacturing a gas barrier film packaging material according to any one of [1] to [11],
in which the width of the support is 250 to 1000 mm.

The method of manufacturing a gas barrier film packaging material according to any one of [1] to [12],
in which a winding length of the gas barrier film packaging material in the winding step is 1300 m or less.

The method of manufacturing a gas barrier film packaging material according to any one of [1] to [13],
in which the adhesive is a two-liquid curable adhesive.

The method of manufacturing a gas barrier film packaging material according to [14],
in which the adhesive is a two-liquid curable urethane adhesive.

According to the present invention, a gas barrier film packaging material including a gas barrier film and a thermal fusion layer and having a sufficient adhesive strength between the thermal fusion layer and the gas barrier film can be manufactured.

### BRIEF DESCRIPTION OF THE DRAWINGS

FIG. 1 is a diagram conceptually showing an example of a gas barrier film packaging material manufactured using a manufacturing method according to the present invention.

FIG. 2 is a partially enlarged view of FIG. 1.

FIG. 3 is a diagram conceptually showing an example of an organic film forming device.

FIG. 4 is a diagram conceptually showing an example of an inorganic film forming device.

FIG. 5 is a diagram conceptually showing an example of a gas barrier film packaging material manufactured using a manufacturing method in the related art.

### DESCRIPTION OF THE PREFERRED EMBODIMENTS

Hereinafter, a method of manufacturing a gas barrier film packaging material according to an embodiment of the present invention will be described in detail based on a preferred embodiment shown in the accompanying drawings.

In the present invention, numerical ranges represented by “to” include numerical values before and after “to” as lower limit values and upper limit values.

Further, all the drawings described below are conceptual views for describing the present invention. Accordingly, a size, a thickness, a shape, a positional relationship, and the like of each of members are different from the actual ones.

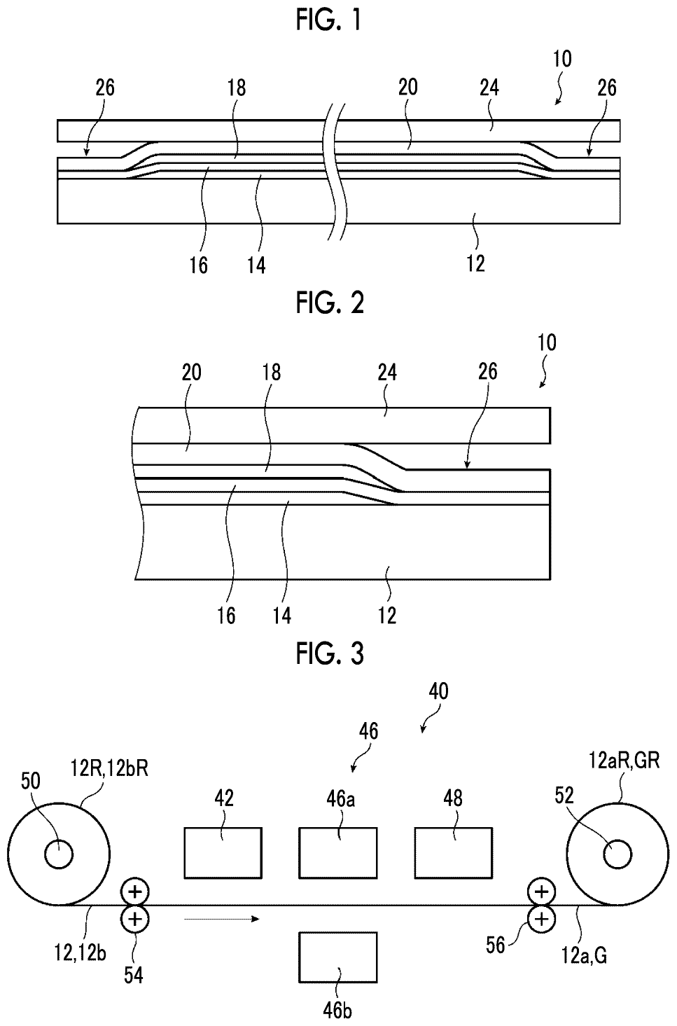

FIG. 1 is a diagram conceptually showing an example of a gas barrier film packaging material manufactured using the method of manufacturing a gas barrier film packaging material according to the embodiment of the present invention. FIG. 2 conceptually shows a partially enlarged view of an end part of the gas barrier film packaging material shown in FIG. 1.

The gas barrier film packaging material manufactured using the method of manufacturing a gas barrier film packaging material according to the embodiment of the present invention is significantly elongated and, in the example shown in FIGS. 1 and 2, is elongated in a direction perpendicular to the paper plane. Accordingly, both end parts of the gas barrier film packaging material shown in FIG. 1 are both end parts of the gas barrier film packaging material in a width direction (lateral direction), and an end part of the gas barrier film packaging material shown in FIG. 2 is one end part of the gas barrier film packaging material in the width direction.

As shown in FIGS. 1 and 2, a gas barrier film packaging material 10 manufactured using the method of manufacturing a gas barrier film packaging material according to the embodiment of the present invention includes a support 12, an underlying organic layer 14, an inorganic layer 16, a protective organic layer 18, an adhesive layer 20, and a thermal fusion layer 24.

In the following description, “the method of manufacturing a gas barrier film packaging material according to the embodiment of the present invention” will also be referred to as “the manufacturing method according to the embodiment of the present invention”.

In the gas barrier film packaging material 10, the underlying organic layer 14, the inorganic layer 16, and the protective organic layer 18 form a gas barrier layer according to the embodiment of the present invention, and the gas barrier layer and the support 12 form a gas barrier film according to the embodiment of the present invention.

The gas barrier layer in the example shown in the drawing includes one laminated structure of the underlying organic layer 14 and the inorganic layer 16. However, the gas barrier film packaging material manufactured using the manufacturing method according to the embodiment of the present invention is not limited to this example.

For example, in the gas barrier film packaging material manufactured using the manufacturing method according to the embodiment of the present invention, the gas barrier layer may include two laminated structures of the underlying organic layer 14 and the inorganic layer 16, the two laminated structures including the underlying organic layer 14, the inorganic layer 16, the underlying organic layer 14, and the inorganic layer 16 in this order from the support 12 side. In addition, in the gas barrier film packaging material manufactured using the manufacturing method according to the embodiment of the present invention, the gas barrier layer may include three laminated structures of the underlying organic layer 14 and the inorganic layer 16, the three laminated structures including the underlying organic layer 14, the inorganic layer 16, the underlying organic layer 14, the inorganic layer 16, the underlying organic layer 14, and the inorganic layer 16 in this order from the support 12 side. Further, in the gas barrier film packaging material manufactured using the manufacturing method according to the embodiment of the present invention, the gas barrier layer may include four or more laminated structures of the underlying organic layer 14 and the inorganic layer 16.

That is, in the gas barrier film packaging material manufactured using the manufacturing method according to the embodiment of the present invention, various layer configurations can be used as long as the gas barrier layer includes one or more laminated structures of the underlying organic layer 14 and the inorganic layer 16 and the protective organic layer 18 is provided on the upper most layer.

Here, in the gas barrier film packaging material manufactured using the manufacturing method according to the embodiment of the present invention, a non-formation region 26 not including the laminated structure of the underlying organic layer 14 and the inorganic layer 16 and the protective organic layer 18 is provided at both end parts of the gas barrier film in the width direction.

In the gas barrier layer of the gas barrier film packaging material in the example shown in the drawing, only the inorganic layer 16 is formed in the non-formation region 26.

This point will be described in detail below.

### <Support>

As the support 12, a well-known sheet-shaped material (a film or a plate-shaped material) that is used as a support for various gas barrier films, various laminated functional films, and the like can be used.

A material of the support 12 is not particularly limited, and various materials can be used as long as the underlying organic layer 14 and the inorganic layer 16 can be formed. Preferable examples of the material of the support 12 include various resin materials.

Examples of the material of the support 12 include polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), an acrylonitrile-butadiene-styrene copolymer (ABS), a cycloolefin copolymer (COC), a cycloolefin polymer (COP), triacetyl cellulose (TAC), and an ethylene-vinyl alcohol copolymer (EVOH).

The thickness of the support 12 can be appropriately set depending on the use, the material, and the like.

The thickness of the support 12 is not limited and may be appropriately set depending on the forming material such that the mechanical strength of the gas barrier film packaging material 10 can be sufficiently ensured and sufficient flexibility can be obtained.

Here, in the manufacturing method according to the embodiment of the present invention, the thickness of the support 12 is preferably 50 to 125 μm. In addition, the width of the support 12 is also not limited and is preferably 250 to 1000 mm. This point will be described in detail below.

In the support 12, an easy adhesion layer for improving adhesiveness with another layer to be laminated may be provided on one surface or both surfaces.

### <Underlying Organic Layer>

In the gas barrier film packaging material 10, the underlying organic layer 14 is formed on one surface of the support 12.

The underlying organic layer 14 consists of, for example, an organic compound obtained by polymerization (crosslinking or curing) of a monomer, a dimer, an oligomer, or the like.

The underlying organic layer 14 functioning as the underlayer of the inorganic layer 16 is an underlayer for appropriately forming the inorganic layer 16.

The underlying organic layer 14 formed on the surface of the support 12 embeds unevenness of the surface of the support 12, foreign matter attached to the surface, and the like to appropriately planarize the formation surface of the inorganic layer 16 such that the inorganic layer 16 can be appropriately formed.

As described above, in the present invention, the gas barrier layer may include a plurality of laminated structures of the inorganic layer 16 and the underlying organic layer 14. In this case, the second or subsequent underlying organic layer 14 is formed on the inorganic layer 16. Even in this configuration, the underlying organic layer 14 functioning as the underlayer (the formation surface of the inorganic layer 16) of the inorganic layer 16 exhibits the same action.

In particular, by providing the underlying organic layer 14 on the surface of the support 12, the inorganic layer 16 that mainly exhibits gas barrier properties can be appropriately formed.

The underlying organic layer 14 is formed, for example, by curing a composition for forming an organic layer, that includes an organic compound (a monomer, a dimer, a trimer, an oligomer, a polymer, and the like). The composition for forming an organic layer may include one kind or two or more kinds of organic compounds.

The underlying organic layer 14 includes, for example, a thermoplastic resin and an organic silicon compound. Examples of the thermoplastic resin include polyester, a (meth)acrylic resin, a methacrylic acid-maleic acid copolymer, polystyrene, a transparent fluororesin, polyimide, fluorinated polyimide, polyamide, polyamide imide, polyether imide, cellulose acylate, polyurethane, polyether ether ketone, polycarbonate, an alicyclic polyolefin, polyarylate, polyethersulfone, polysulfone, fluorene ring-modified polycarbonate, alicyclic-modified polycarbonate, fluorene ring-modified polyester, and an acrylic compound. Examples of the organic silicon compound include polysiloxane.

From the viewpoints of high strength and glass transition temperature, it is preferable that the underlying organic layer 14 includes a polymer of a radically curable compound and/or a cationically curable compound having an ether group.

From the viewpoint of reducing the refractive index of the underlying organic layer 14, it is preferable that the underlying organic layer 14 includes a (meth)acrylic resin including, as a major component, a polymer of a monomer, an oligomer, or the like of (meth)acrylate. By reducing the refractive index of the underlying organic layer 14, transparency increases, and a light-transmitting property is improved.

It is more preferable that the underlying organic layer 14 includes a (meth)acrylic resin including, as a major component, a monomer, a dimer, an oligomer, or the like of a bi- or higher functional (meth)acrylate such as dipropylene glycol di(meth)acrylate (DPGDA), trimethylolpropane tri(meth)acrylate (TMPTA), or dipentaerythritol hexa(meth)acrylate (DPHA), and it is still more preferable that the underlying organic layer 14 includes a (meth)acrylic resin including, as a major component, a polymer of a monomer or a polymer such as a dimer, an oligomer of a tri- or higher functional (meth)acrylate. In addition, a plurality of (meth)acrylic resins may be used. The major component refers to a component having the highest content mass ratio among components included.

It is preferable that the composition for forming an organic layer includes an organic solvent, a surfactant, and a silane coupling agent in addition to the organic compound.

In a case where a plurality of underlying organic layers 14 are provided, that is, in a case where plural sets of combinations of the underlying organic layers 14 and the inorganic layers 16 are provided as described above, the materials of the underlying organic layers 14 may be the same as or different from each other.

The thickness of the underlying organic layer 14 is not limited and can be appropriately set according to components in the composition for forming an organic layer, the support 12 used, and the like.

The thickness of the underlying organic layer 14 is preferably 0.1 to 5 μm and more preferably 0.2 to 3 μm. It is preferable that the thickness of the underlying organic layer 14 is 0.1 μm or more from the viewpoint of embedding unevenness of the surface of the support 12, foreign matter attached to the surface, and the like such that the surface of the underlying organic layer 14 can be planarized. It is preferable that the thickness of the underlying organic layer 14 is 5 μm or less from the viewpoints that, for example, cracks of the underlying organic layer 14 can be prevented, the flexibility of the gas barrier film can be improved, and the thickness and weight of the gas barrier film can be reduced.

In a case where a plurality of underlying organic layers 14 are provided, that is, a case where plural sets of combinations of the inorganic layers 16 and the underlying organic layers 14 are provided, the thicknesses of the respective underlying organic layers 14 may be the same as or different from each other.

The underlying organic layer 14 can be formed with a well-known method depending on materials.

For example, the underlying organic layer 14 can be formed with a coating method of applying the above-described composition for forming an organic layer and drying the composition for forming an organic layer. During the formation of the underlying organic layer 14 with the coating method, the dried composition for forming an organic layer is irradiated with ultraviolet rays to polymerize (crosslink) the organic compound in the composition for forming an organic layer.

In the manufacturing method according to the embodiment of the present invention, the underlying organic layer 14 may be formed through roll-to-roll (RtoR) of applying and drying the composition for forming an organic layer while transporting a support. In the following description, “roll-to-roll” will also be referred to as “RtoR”.

In the manufacturing method according to the embodiment of the present invention, the underlying organic layer 14 is not formed in the non-formation region 26 in both end parts in the width direction of the support 12.

### <Inorganic Layer>

The inorganic layer 16 is a thin film including an inorganic compound, and is provided on a surface of the underlying organic layer 14. In the gas barrier film forming the gas barrier film packaging material 10, the inorganic layer 16 mainly exhibits gas barrier properties.

The surface of the support 12 includes a region such as unevenness or shadow of foreign matter to which the inorganic compound is not likely to adhere. By providing the underlying organic layer 14 and forming the inorganic layer 16 thereon, the region to which the inorganic compound is not likely to adhere is covered. Therefore, the inorganic layer 16 can be formed on the formation surface of the inorganic layer 16 without a gap.

A material of the inorganic layer 16 is not particularly limited, and various inorganic compounds that are used for a well-known gas barrier layer consisting of an inorganic compound exhibiting gas barrier properties can be used.

Examples of a material of the inorganic layer 16 include inorganic compounds, for example, a metal oxide such as aluminum oxide, magnesium oxide, tantalum oxide, zirconium oxide, titanium oxide, or indium tin oxide (ITO); a metal nitride such as aluminum nitride; a metal carbide such as aluminum carbide; a silicon oxide such as silicon oxide, silicon oxynitride, silicon oxycarbide, or silicon oxynitride-carbide; a silicon nitride such as silicon nitride or silicon nitride-carbide; a silicon carbide such as silicon carbide; a hydride thereof; a mixture of two or more kinds thereof; and a hydrogen-containing material thereof. In addition, a mixture of two or more kinds of the examples can be used.

In particular, silicon nitride, silicon oxide, silicon oxynitride, aluminum oxide, or a mixture of two or more kinds thereof is preferably used from the viewpoints that transparency is high and excellent gas barrier properties can be exhibited. In particular, a compound including silicon is preferably used, and silicon nitride is more preferably used from the viewpoint that excellent gas barrier properties can be exhibited.

The thickness of the inorganic layer 16 is not particularly limited and can be appropriately set depending on materials such that desired gas barrier properties can be exhibited.

The thickness of the inorganic layer 16 is preferably 10 to 150 nm, more preferably 12 to 100 nm, and still more preferably 15 to 75 nm.

It is preferable that the thickness of the inorganic layer 16 is 10 nm or more from the viewpoint that the inorganic layer 16 stably exhibiting sufficient gas barrier performance can be formed. In addition, in a case where the inorganic layer 16 is generally brittle and is excessively thick, breakage, cracking, peeling, or the like may occur. However, by adjusting the thickness of the inorganic layer 16 to be 150 nm or less, the occurrence of breakage can be suppressed.

As described above, in a case where a plurality of inorganic layers 16 are provided, the thicknesses of the inorganic layers 16 may be the same as or different from each other.

In addition, in a case where a plurality of inorganic layers 16 are provided, the materials of the inorganic layers 16 may be the same as or different from each other.

The inorganic layer 16 can be formed with a well-known method depending on materials.

For example, plasma CVD such as capacitively coupled plasma (CCP)-chemical vapor deposition (CVD) or inductively coupled plasma (ICP)-CVD, atomic layer deposition (ALD), sputtering such as magnetron sputtering or reactive sputtering, or various vapor deposition methods such as vacuum deposition can be suitably used.

In the manufacturing method according to the embodiment of the present invention, the inorganic layer 16 is also formed through RtoR.

### <Protective Organic Layer>

The protective organic layer 18 is a layer for protecting the inorganic layer 16, the layer consisting of an organic material. By providing the protective organic layer 18, breakage or the like of the inorganic layer 16 can be prevented.

A material for forming the protective organic layer 18 is not particularly limited, and various well-known organic compounds can be used as in the underlying organic layer 14.

In addition, as the material for forming the protective organic layer 18, a urethane skeleton acrylate polymer such as a polymerizable composition for forming a second organic layer described in paragraphs to of JP2015-171798A may be used. In addition, the composition for forming the protective organic layer 18 may include an additive such as a monomer, an oligomer, or a polymer, a polymerization initiator, and a silane coupling agent, in addition to the urethane skeleton acrylate polymer.

As the protective organic layer 18, a resin film may be used. In this case, a pressure-sensitive adhesive layer may be provided between the resin film as the protective organic layer and the inorganic layer.

Regarding the resin film as the protective organic layer and the pressure-sensitive adhesive layer, a resin layer (resin film) and a well-known bonding layer described in WO2018/211850A and WO2019/049634A can be used.

The thickness of the protective organic layer 18 may be appropriately set depending on the material for forming the protective organic layer 18, the inorganic layer 16, and the like. According to an investigation by the present inventors, the thickness of the protective organic layer 18 is preferably 0.1 to 50 μm, more preferably 0.5 to 25 μm, and still more preferably 1 to 10 μm. By adjusting the thickness of the protective organic layer 18 to be 0.1 μm or more, the inorganic layer 16 can be appropriately protected. In addition, by adjusting the thickness of the protective organic layer 18 to be 50 μm or less, the thickness of the gas barrier film can be reduced.

For example, as in the underlying organic layer 14, the protective organic layer 18 can be formed with a coating method of applying a composition for forming an organic layer including an organic compound for forming the protective organic layer 18 and drying the composition for forming an organic layer. In the manufacturing method according to the embodiment of the present invention, the protective organic layer 18 is also formed through RtoR.

Here, in the manufacturing method according to the embodiment of the present invention, as in the underlying organic layer 14, the protective organic layer 18 is not formed in the non-formation region 26 in both end parts in the width direction of the support 12.

In the gas barrier film packaging material 10 manufactured using the manufacturing method according to the embodiment of the present invention, the adhesive layer 20 is provided on the gas barrier layer to cover the entire surface of the support 12, the gas barrier layer including the laminated structures of the underlying organic layer 14 and the inorganic layer 16 and the protective organic layer 18 that is the upper most layer.

The thermal fusion layer 24 having a width more than or equal to the width of the support 12 adheres to the adhesive layer 20.

### <Thermal Fusion Layer (Heat Seal Layer)>

The thermal fusion layer 24 is a layer for bonding the gas barrier film packaging material 10 to an object such as an infusion bag by thermal fusion (heat sealing).

Basically, the thermal fusion layer 24 is formed of the same forming material as the object to which the gas barrier film packaging material 10 is thermally fused. For example, in a case where the object is an infusion bag, the thermal fusion layer 24 is formed of the same material as the material for forming the infusion bag. That is, in a case where the object to be thermally fused is formed of polyethylene (PE), a sheet-shaped material (film-shaped material) formed of PE may be used as the thermal fusion layer 24, and in a case where the object to be thermally fused is formed of polypropylene (PP), a sheet-shaped material (film-shaped material) formed of PP may be used as the thermal fusion layer 24.

Specifically, as the material for forming the thermal fusion layer 24, a resin film described in paragraph of JP2012-075716A can be used.

In general, the infusion bag is likely to be formed of PE or PP. Therefore, preferable examples of the material for forming the thermal fusion layer 24 include PE and PP.

In addition, the thickness of the thermal fusion layer 24 is not also limited, and may be appropriately selected depending on the material for forming the thermal fusion layer 24 and the shape, state, or the like of the object such as an infusion bag to be thermally fused such that the object can be reliably thermally welded.

Here, in the manufacturing method according to the embodiment of the present invention, the thickness of the thermal fusion layer 24 is preferably 30 to 70 μm. This point will be described in detail below.

In FIGS. 1 and 2, the thermal fusion layer 24 of the non-formation region 26 where the underlying organic layer 14 and the protective organic layer 18 are not formed floats from the adhesive layer 20. However, the present invention is not limited to this example.

That is, in the non-formation region 26, the thermal fusion layer 24 may adhere to the adhesive layer 20, or a region where the thermal fusion layer 24 adheres to the adhesive layer 20 and a region where the thermal fusion layer 24 does not adhere to the adhesive layer 20 may be mixed.

### <Adhesive Layer>

The adhesive layer 20 is a layer for causing the thermal fusion layer 24 and the gas barrier film (protective organic layer 18) to adhere to each other.

As the adhesive layer 20, all of layers consisting of well-known adhesives through which the thermal fusion layer 24 can adhere to the protective organic layer 18 with a necessary adhesive strength can be used. Here, in the manufacturing method according to the embodiment of the present invention, the adhesive is preferably a two-liquid curable adhesive and more preferably a two-liquid curable urethane adhesive (urethane adhesive, polyurethane adhesive).

In addition, the thickness of the adhesive layer 20 is not limited, and may be appropriately set depending on the adhesive such that the protective organic layer 18 and the thermal fusion layer 24 can adhere to each other with a sufficient adhesive strength.

With the manufacturing method according to the embodiment of the present invention, the gas barrier film packaging material 10 including the support, the gas barrier film that includes the gas barrier layer consisting of the laminated structure of the underlying organic layer 14 and the inorganic layer 16, and the protective organic layer 18 that is the upper most layer, the adhesive layer 20, and the thermal fusion layer 24 is manufactured.

Hereinafter, the manufacturing method according to the embodiment of the present invention will be described.

### <Gas Barrier Film Preparation Step>

In the gas barrier film preparation step, the underlying organic layer 14 is formed on one surface of the support 12.

As described above, the underlying organic layer 14 is formed through RtoR with a coating method using a composition for forming an organic layer including an organic compound for forming the underlying organic layer 14.

FIG. 3 conceptually shows an organic film forming device 40 for forming the underlying organic layer 14 and the protective organic layer 18.

The organic film forming device 40 forms the underlying organic layer 14 and the protective organic layer 18 through RtoR. That is, the organic film forming device 40 applies the above-described composition for forming an organic layer for forming the underlying organic layer 14 or the protective organic layer 18 while transporting the elongated support 12 in a longitudinal direction, dries the applied composition for forming an organic layer, and polymerizes (cures) the organic compound in the composition for forming an organic layer by light irradiation to form the underlying organic layer 14 and the protective organic layer 18.

The organic film forming device 40 in the example shown in the drawing includes, for example, an application unit 42, a drying unit 46, a light irradiation unit 48, a rotating shaft 50, a winding shaft 52, and transport roller pairs 54 and 56.

In the manufacturing of the gas barrier film packaging material 10, in a case where the underlying organic layer 14 is formed, a support roll 12R where the elongated support 12 is wound is charged into the rotating shaft 50 of the organic film forming device 40.

In a case where the support roll 12R is charged into the rotating shaft 50, the support 12 is drawn from the support roll 12R, passes the application unit 42, the drying unit 46, and the light irradiation unit 48 through the transport roller pair 54, and reaches the winding shaft 52 through the transport roller pair 56, that is, a passes a predetermined transport path.

The support 12 drawn from the support roll 12R is transported to the application unit 42 by the transport roller pair 54, and a composition for forming an organic layer that forms the underlying organic layer 14 is applied to a surface of the support 12.

The composition for forming an organic layer that forms the underlying organic layer 14 includes an organic solvent, an organic compound (a monomer, a dimer, a trimer, an oligomer, a polymer, and the like) for forming the underlying organic layer 14, a surfactant, and a silane coupling agent as described above.

In addition, various well-known methods such as a die coating method, a dip coating method, an air knife coating method, a curtain coating method, a roller coating method, a wire bar coating method, and a gravure coating method can be used for applying the composition for forming an organic layer in the application unit 42.

Here, in the manufacturing method according to the embodiment of the present invention, as shown in FIGS. 1 and 2, the underlying organic layer 14 is not formed in the non-formation region 26 provided in both end parts of the support 12.

Accordingly, the application unit 42 does not apply the composition for forming an organic layer to the non-formation region 26. The application region of the support 12 in the width direction may be controlled using a well-known corresponding to the coating method using the application unit 42.

Next, the support 12 to which the composition for forming an organic layer that forms the underlying organic layer 14 is heated by the drying unit 46 to remove the organic solvent, and dry the composition for forming an organic layer.

The drying unit 46 includes a drying unit 46a that performs heating and drying from the surface side (front surface side) to which the composition for forming an organic layer is applied and a drying unit 46b that performs heating and drying from the opposite surface side (back surface side), and dries the composition for forming an organic layer from both of the front surface side and the back surface side. In the drying unit 46, only any one of the drying unit 46a or the drying unit 46b may be used.

Heating in the drying unit 46 may be performed using a well-known method for heating a sheet-shaped material. For example, the drying unit 46a on the front surface side is a hot-air drying unit, and the drying unit 46b on the back surface side is a heating roller (a guide roller having a heating mechanism).

Next, the support 12 in which the composition for forming an organic layer that forms the underlying organic layer 14 is dried is irradiated with ultraviolet rays or the like by the light irradiation unit 48 such that the organic compound is polymerized (crosslinked) and cured to form the underlying organic layer 14. Further, optionally, the curing of the organic compound that forms the underlying organic layer 14 may be performed in an inert atmosphere such as a nitrogen atmosphere.

The light irradiation unit 48 is optionally provided. That is, in a case where the effect by the ultraviolet irradiation or the like of the underlying organic layer 14 is unnecessary, the organic film forming device 40 does not need to drive the light irradiation unit 48, or does not need to include the light irradiation unit 48.

The support 12 on which the underlying organic layer 14 is formed is transported by the transport roller pair 56 and wound into a roll shape by the winding shaft 52.

Optionally, in the transport roller pair 56, a protective film may be laminated on the surface of the underlying organic layer 14.

In a case where the formation of the underlying organic layer 14 having a predetermined length is finished, the support 12 is optionally cut. Next, a support 12a where the underlying organic layer 14 is formed is wound to form a support roll 12aR.

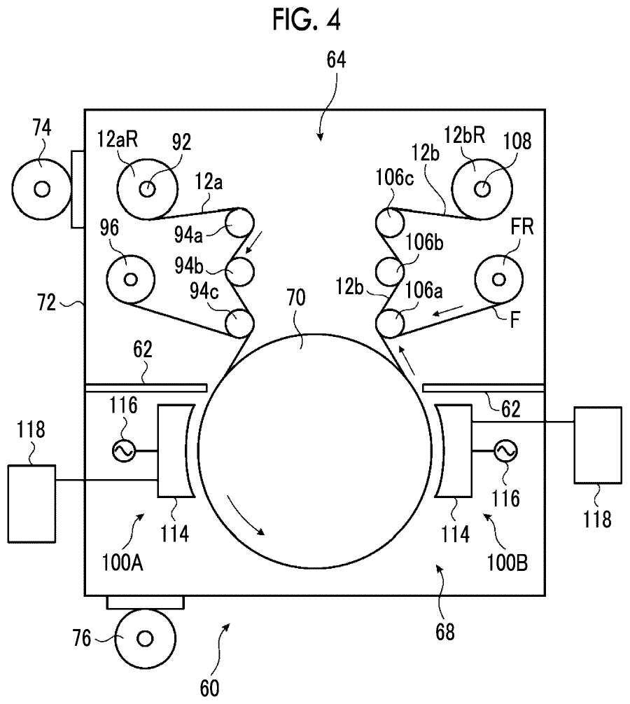

Next, the support roll 12aR is supplied to an inorganic film forming device 60 shown in FIG. 4, and is provided for forming the inorganic layer 16.

The inorganic film forming device 60 is separated into a supply/winding chamber 64 and a film formation chamber 68 by two partition walls 62 and a drum 70.

The inorganic film forming device 60 also forms the inorganic layer 16 through RtoR. That is, the inorganic film forming device 60 forms the inorganic layer 16 on the underlying organic layer 14 of the support 12 while transporting the elongated support 12 on which the underlying organic layer 14 is formed in the longitudinal direction, and subsequently laminates a protective film F on the surface of the inorganic layer 16.

The inorganic film forming device 60 includes a vacuum chamber 72. As described above, the inside of the vacuum chamber 72 is separated into the supply/winding chamber 64 in the upper section of the drawing and the film formation chamber 68 in the lower section of the drawing by the two partition walls 62 and the drum 70.

The supply/winding chamber 64 includes an evacuation unit 74. By driving the evacuation unit 74, a pressure in the supply/winding chamber 64 can be adjusted. The film formation chamber 68 includes an evacuation unit 76. By driving the evacuation unit 76, a pressure in the film formation chamber 68 can be adjusted.

In the supply/winding chamber 64, a rotating shaft 92, pass rollers 94a to 94c, the support roll 12aR, pass rollers 106a to 106c, and a winding shaft 108 are disposed.

In the film formation chamber 68, a first film forming unit 100A and a second film forming unit 100B are disposed.

The inorganic film forming device 60 forms the inorganic layer 16 on the underlying organic layer 14 while transporting the elongated support 12 on which the underlying organic layer 14 is formed in the longitudinal direction.

First, the support roll 12aR obtained by winding the support 12a on which the underlying organic layer 14 is formed is charged into the rotating shaft 92. Next, the support 12 drawn from the support roll 12aR is inserted into a predetermined transport path that reaches the winding shaft 108 through the pass rollers 94a to 94c, the drum 70, and the pass rollers 106a to 106c.

The support 12a drawn from the support roll 12aR is guided by the pass rollers 94a to 94c and is wound around the drum 70. While the support 12a is transported in a predetermined path, the inorganic layer 16 is formed on the support 12a by the first film forming unit 100A and/or the second film forming unit 100B. In a case where the protective film is provided to cover the underlying organic layer 14, the protective film is peeled off by, for example, the pass roller 94c before winding the support 12a around the drum 70. The protective film peeled off by the pass roller 94c is wound around a roll 96.

The drum 70 is equipped with a temperature adjustment unit. Optionally, while cooling or heating the support 12a using the drum 70, the inorganic layer 16 is formed on the support 12a by the first film forming unit 100A and/or the second film forming unit 100B.

Further, bias power can be supplied to the drum 70.

A film forming method in the first film forming unit 100A and the second film forming unit 100B is, for example, CCP-CVD.

The first film forming unit 100A and the second film forming unit 100B have the same configuration, and include a shower electrode 114 forming an electrode pair with the drum 70, a high frequency power supply 116, and a gas supply unit 118.

The shower electrode 114 is a well-known shower electrode (shower plate) used for plasma CVD, which has an opening for supplying raw material gas onto a surface facing the drum 70.

The high frequency power supply 116 supplies plasma excitation power to the shower electrode 114, and is a well-known high frequency power supply used for plasma CVD.

The gas supply unit 118 supplies the raw material gas to the shower electrode 114, and is a well-known gas supply unit used for plasma CVD. For example, in a case where silicon nitride is formed as the inorganic layer 16, examples of the raw material gas include silane gas, ammonia gas, and hydrogen gas.

Moreover, a thickness of the inorganic layer 16 may be adjusted by a well-known method such as adjustment of plasma excitation power, adjustment of a film formation time, that is, a transportation speed of the support 12, or adjustment of the amount of the raw material gas to be supplied.

The protective film F is laminated on a support 12b on which the inorganic layer 16 is formed on the underlying organic layer 14 in the pass roller 106a immediately downstream of the drum 70. The protective film F is fed from a resin film roll FR and transported to the pass roller 106a.

The support 12b where the protective film F is laminated in the pass roller 106a is guided to the pass rollers 106a to 106c, is transported to the winding shaft 108, and is wound around the winding shaft 108 to obtain a support roll 12bR around which the support 12b where the underlying organic layer 14 and the inorganic layer 16 are formed is wound.

Next, the vacuum chamber 72 is opened to the atmosphere, and purified dry air is introduced into the vacuum chamber 72. Next, the support roll 12bR is taken out from the vacuum chamber 72.

Here, in the manufacturing method according to the embodiment of the present invention, it is preferable that the inorganic layer 16 is also formed in the non-formation region 26 where the underlying organic layer 14 and the protective organic layer 18 are not formed.

As described above, the inorganic layer 16 is formed by plasma CVD or the like. In this case, in order to control the region where the inorganic layer 16 is formed, a mask or the like needs to be used. Here, during the film formation by plasma CVD, the region where the inorganic layer 16 is formed at a high temperature. Therefore, the mask needs to be formed of a metal that can endure a high temperature. However, in a case where the mask formed of a metal is disposed in the vicinity of the shower electrode 114, abnormal discharge occurs between the mask and the shower electrode 114, and the appropriate inorganic layer 16 cannot be formed.

In consideration of this point, it is preferable that the inorganic layer 16 is formed to cover the entire surface of the support 12 including the non-formation region 26 without being limited to the forming region.

In a case where two or more laminated structures of the underlying organic layer 14 and the inorganic layer 16 are formed, the same formation of the underlying organic layer 14 and the inorganic layer 16 may be repeated according to the number of the laminated structures to be formed.

The support roll 12bR around which the support 12b where the inorganic layer 16 is formed is wound is charged into the organic film forming device 40 again.

The support 12b is drawn from the support roll 12bR, and the protective film F is peeled off. Next, as in the above-described formation of the underlying organic layer 14, the composition for forming an organic layer that forms the protective organic layer 18 is applied by the application unit 42, is dried by the drying unit 46, and is irradiated with ultraviolet rays by the light irradiation unit 48 to polymerize and cure the organic compound for forming the protective organic layer 18. As a result, a gas barrier film G including the gas barrier layer consisting of the underlying organic layer 14, the inorganic layer 16, and the protective organic layer 18 is prepared.

As described above, the gas barrier film G is wound in a roll shape by the winding shaft 52 to obtain a gas barrier film roll GR where the gas barrier film G is wound.

In the manufacturing method according to the embodiment of the present invention, as in the underlying organic layer 14, the protective organic layer 18 is also not formed in the non-formation region 26 in both end parts of the support 12.

### <Bonding Step and Winding Step>

Next, the gas barrier film is provided for the bonding step.

The bonding step is also formed through RtoR.

In the bonding step, first, the gas barrier film is fed from the gas barrier film roll, the adhesive is applied to the gas barrier layer while transporting the gas barrier film in the longitudinal direction, and subsequently the adhesive is dried to form the adhesive layer 20. In the present invention, in order to make the thickness of the adhesive layer 20 uniform over the entire surface, the adhesive is applied to cover the entire surface of the support 12.

The adhesive is not limited, and various well-known adhesives capable of adhering the thermal fusion layer 24 can be used according to the thermal fusion layer 24 to be subsequently bonded. As the adhesive, a two-liquid curable adhesive is preferable, and a two-liquid curable urethane adhesive is more preferable as described above. In addition, the drying of the adhesive may be performed using a well-known method corresponding to the adhesive as in the above-described drying unit 46 of the organic film forming device 40.

Next, the gas barrier film where the adhesive layer 20 is formed is transported, the thermal fusion layer 24 is laminated on the adhesive layer 20, and the adhesive layer 20 and the thermal fusion layer 24 are bonded to each other to obtain a gas barrier film packaging material.

The width of the thermal fusion layer 24 is more than or equal to the width of the support 12. In the manufacturing method according to the embodiment of the present invention, the adhesive is applied to cover the entire surface of the support 12 such that the adhesive layer 20 is formed. In addition, next, in the manufacturing method according to the embodiment of the present invention, the gas barrier film packaging material is wound in the winding step. Therefore, in a case where the width of the thermal fusion layer 24 is less than the width of the support 12, the adhesive layers 20 of the gas barrier film packaging material laminated by winding adhere to each other such that an appropriate product cannot be manufactured.

Next, by winding the gas barrier film packaging material that is prepared as described above and includes the gas barrier film including the support 12 and the gas barrier layer consisting of the underlying organic layer 14, the inorganic layer 16, and the protective organic layer 18, the adhesive layer 20, and the thermal fusion layer 24 adhering to the adhesive layer 20, a gas barrier film packaging material roll where the gas barrier film packaging material is wound is obtained.

In this case, the diameter of a winding core of the gas barrier film packaging material in this case is not limited. For example, various well-known winding cores having a diameter of 3 inches or 6 inches can be used.

### <Aging Step>

The gas barrier film packaging material roll where the gas barrier film packaging material is wound is accommodated in an aging chamber where the room temperature can be controlled. As a result, an aging step of heating and aging the gas barrier film packaging material is performed.

The aging is a process of keeping the gas barrier film packaging material in a heated state for a predetermined time to cure the adhesive. In other words, the aging is a process of keeping the gas barrier film packaging material in the heated state for a predetermined time to promote the reaction (curing) of the adhesive.

Here, in the manufacturing method according to the embodiment of the present invention, the non-formation region 26 where the laminated structure of the underlying organic layer 14 and the inorganic layer 16 and the protective organic layer 18 are not formed is provided in both end parts of the gas barrier film packaging material in the width direction.

Therefore, according to the manufacturing method according to the embodiment of the present invention, in the aging step, the aging, that is, the curing reaction of the adhesive can be appropriately promoted. As a result, in the manufacturing method according to the embodiment of the present invention, the aging time can be reduced, and the gas barrier film packaging material 10 having a sufficient adhesive strength between the thermal fusion layer 24 and the gas barrier film (gas barrier layer) can be manufactured.

In consideration of the production efficiency, the manufacturing cost, and the like, for example, an elongated product of the gas barrier film packaging material having a length of 1000 m or more is continuously manufactured. Therefore, the aging is performed in the state of the gas barrier film packaging material roll where the gas barrier film packaging material is wound.

Here, during the aging, particularly, during the aging of a two-liquid curable adhesive such as the aging of a two-liquid curable urethane adhesive (urethane adhesive), water is necessary to promote the curing reaction of the adhesive.

Incidentally, according to an investigation by the present inventors, in a gas barrier film packaging material in the related art where a thermal fusion layer adheres to a gas barrier film through an adhesive, particularly, in a gas barrier film packaging material having high gas barrier performance of the gas barrier film, a long period of time is required for aging. In addition, in the gas barrier film packaging material having high gas barrier performance of the gas barrier film, even in a case where a very long period of aging is performed, a sufficient adhesive strength between the thermal fusion layer 24 and the gas barrier film cannot be obtained, and the thermal fusion layer 24 may be peeled off.

As a permeation path of water into the adhesive layer 20, that is, an uncured adhesive during the aging, permeation from a film surface and permeation from an end part of the adhesive layer 20 can be considered.

As described above, the aging is performed in a state where the gas barrier film packaging material is wound. Accordingly, the gas barrier film packaging material is aged in a state where it is laminated in several layers. That is, the gas barrier film packaging material is aged in a state where the gas barrier film is laminated in several layers.

Therefore, in the gas barrier film packaging material roll, toward the winding core side of the roll, that is, toward the inside of the roll, gas barrier properties are increased, and permeation of water from the film surface is reduced. In particular, in a gas barrier film packaging material including a high-performance gas barrier film where a water vapor transmission rate is 1.0×10⁻⁴ g/(m²·day) or less, permeation of water from the film surface is significantly small, and permeation of water from the film surface into the adhesive layer 20 is significantly small in the vicinity of the center of winding.

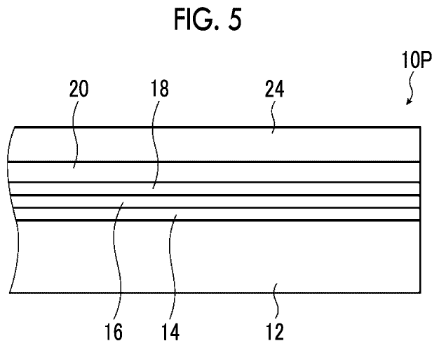

Here, as conceptually shown in FIG. 5, in a gas barrier film packaging material 10P in the related art, the laminated structure of the underlying organic layer 14 and the inorganic layer 16 and the protective organic layer 18 are also formed up to the end parts in the width direction.

Accordingly, during the aging of the gas barrier film packaging material including the high-performance gas barrier film, permeation of water into the adhesive layer 20 occurs main from the end parts of the adhesive layer 20.

Therefore, during the manufacturing of the gas barrier film packaging material 10P in the related art, sufficient water cannot be supplied to the adhesive layer 20 during aging, aging needs to be performed for a long period of time. In addition, even in a case where aging is performed for a long period of time, there is a case where the adhesive layer 20 cannot be sufficiently cured. In particular, during the manufacturing of the gas barrier film packaging material 10P including the high-performance gas barrier film, sufficient water cannot be supplied to the adhesive layer 20 during aging, aging needs to be performed for a very long period of time. In addition, even in a case where aging is performed for a long period of time, there is a case where the adhesive layer 20 cannot be sufficiently cured.

As a result, in the gas barrier film packaging material 10P in the related art, even in a case where a very long period of aging is performed, the adhesive strength between the thermal fusion layer 24 and the gas barrier film is insufficient, and the thermal fusion layer 24 may be peeled off.

On the other hand, in the manufacturing method according to the embodiment of the present invention, the non-formation region 26 where the laminated structure of the underlying organic layer 14 and the inorganic layer 16 and the protective organic layer 18 are not formed is provided in both end parts of the gas barrier film packaging material 10 in the width direction. Here, in the manufacturing method according to the embodiment of the present invention, the non-formation region 26 where the underlying organic layer 14 and the protective organic layer 18 is not formed is provided in both end parts of the gas barrier film packaging material 10 in the width direction.

Therefore, as shown in FIG. 1, even in a case where the inorganic layer 16 is formed in the non-formation region 26, this region does not include the underlying organic layer 14. Therefore, the inorganic layer 16 does not exhibit sufficient gas barrier properties. Further, the protective organic layer 18 is also not formed in the non-formation region 26. Therefore, the inorganic layer 16 of the non-formation region 26 is fractured, for example, while being transported by the transport roller pair during the formation of the protective organic layer 18. In regard to this point, sufficient gas barrier properties are not exhibited.

Therefore, in the manufacturing method according to the embodiment of the present invention, during aging, water can permeate into the adhesive layer 20 not only from an edge surface of the adhesive layer 20 but also from the non-formation region 26.

As a result, in the manufacturing of the gas barrier film packaging material, sufficient water can be made permeate into the adhesive layer 20 during aging to promote the curing reaction. That is, with the manufacturing method according to the embodiment of the present invention, the adhesive layer 20 can be appropriately cured by aging, and the gas barrier film packaging material 10 having a sufficient adhesive strength between the thermal fusion layer 24 and the gas barrier film can be manufactured. Accordingly, with the manufacturing method according to the embodiment of the present invention, the aging time can be reduced.

In the non-formation region 26, even in a case where the adhesive layer 20 and the thermal fusion layer 24 are bonded to each other, gas barrier properties are significantly low because the thermal fusion layer 24 is formed of polyethylene, polypropylene, or the like. Therefore, in the non-formation region 26, even in a case where the adhesive layer 20 and the thermal fusion layer 24 are bonded to each other, water can permeate into the adhesive layer 20 through the thermal fusion layer 24.

In the manufacturing method according to the embodiment of the present invention, the size of the non-formation region 26 provided in both ends of the gas barrier film packaging material in the width direction is not limited, and may be appropriately set depending on the gas barrier performance of the gas barrier film, the width of the support 12 to be used, and the like.

According to an investigation by the present inventors, the size of the non-formation region 26 provided in both ends of the gas barrier film packaging material in the width direction is preferably 3% to 15% of the width of the support 12.

The size of the non-formation region 26 is preferably 3% or more of the width of the support 12 from the viewpoint that, for example, the aging time can be more suitably reduced, the adhesive strength between the thermal fusion layer 24 and the gas barrier film can be improved, appropriate sliding properties on a contact surface between the film and an end part holding roller during transport accompanied by contact with the applied surface can be ensured, and the transport can be stabilized.

In addition, the size of the non-formation region 26 is preferably 15% or less of the width of the support 12 from the viewpoint that, for example, the gas barrier film packaging material 10 can be efficiently utilized in the width direction.

The non-formation region 26 is more preferably 6% to 13% and still more preferably 9% to 11% of the width of the support 12.

It is needless to say that the size of the non-formation region 26 is the length of the support 12 in the width direction.

In the manufacturing method according to the embodiment of the present invention, basically, as the gas barrier performance of the gas barrier film to be prepared increases, that is, as the gas barrier performance of the gas barrier film packaging material to be manufactured increases, the effect of the present invention can be suitably exhibited.

In consideration of this point, in the manufacturing method according to the embodiment of the present invention, in the gas barrier film to be prepared and the gas barrier film packaging material to be manufactured, a water vapor transmission rate in the center portion in the width direction is preferably 1.0×10⁻⁴ g/(m²·day) or less, more preferably 8.0×10⁻⁵ g/(m²·day) or less, and still more preferably 5.0×10⁻⁵ g/(m²·day) or less in an environment of a temperature of 25° C. and a relative humidity of 50%.

On the other hand, the non-formation region 26 does not include the laminated structure of the underlying organic layer 14 and the inorganic layer 16 and the protective organic layer 18. Therefore, in a case where the inorganic layer 16 that exhibits gas barrier properties is formed, sufficient gas barrier properties are not exhibited as described above. That is, the gas barrier performance of the non-formation region 26 is lower than that in a typical region of the gas barrier film, specifically, in the center portion in the width direction.

Here, a water vapor transmission rate of the gas barrier film in the non-formation region 26 and the gas barrier film packaging material to be manufactured is preferably 1.0×10⁻¹ g/(m²·day) or more in the environment of a temperature of 25° C. and a relative humidity of 50%. The water vapor transmission rate of the gas barrier film in the non-formation region 26 and the gas barrier film packaging material to be manufactured is preferably 1.0×10⁻¹ g/(m²·day) or more from the viewpoints that, for example, the aging time can be more suitably reduced, and the adhesive strength between the thermal fusion layer 24 and the gas barrier film can be improved.

The water vapor transmission rate of the gas barrier film in the non-formation region 26 and the gas barrier film packaging material to be manufactured is more preferably 5.0×10⁻¹ g/(m²·day) or more and still more preferably 1.0 g/(m²·day) or more.

In the manufacturing method according to the embodiment of the present invention, the tension of winding of the gas barrier film packaging material in the winding step is not limited, and may be appropriately set depending on the stiffness and the like of the gas barrier film packaging material.

The tension of winding of the gas barrier film packaging material in the winding step is preferably 10 to 200 N.

The tension of winding of the gas barrier film packaging material in the winding step is preferably 10 N or more from the viewpoint that, for example, disorder in the shape of winding caused by loosening can be prevented.

On the other hand, the tension of winding of the gas barrier film packaging material in the winding step is preferably 200 N or less from the viewpoints that, for example, the compression of the thermal fusion layer 24 in the thickness direction can be suppressed to sufficiently exhibit the function as the permeation path of water described below and the fracture of the gas barrier layer of the gas barrier film can be prevented.

The tension of winding of the gas barrier film packaging material is more preferably 20 to 150 N and still more preferably 30 to 100 N.

Although described below, in the manufacturing method according to the embodiment of the present invention, it is preferable that aging is performed in the aging step for 48 hours or longer. On the other hand, the rate of the application of the adhesive through RtoR and the lamination of the thermal fusion layer is a significantly high speed of, for example, about 1 hour per 1000 m. That is, in the manufacturing method according to the embodiment of the present invention, the aging time is longer than that in the other steps.

In addition, in consideration of the production rate of the gas barrier film packaging material before aging, a significantly wide aging chamber is necessary, and the wide aging chamber needs to be used with a high utilization efficiency.

Here, in a case where collapse or the like of the gas barrier film packaging material roll caused by loosening occurs, the loading and unloading of the gas barrier film packaging material roll in the aging chamber is inhibited, and the utilization efficiency of the aging chamber, that is, the production efficiency of the gas barrier film packaging material significantly decreases. Accordingly, it is significantly important that the shape of winding of the gas barrier film packaging material roll is appropriate.

In the manufacturing method according to the embodiment of the present invention, the winding length of the gas barrier film packaging material in the winding step is not limited, and may be appropriately set depending on the thickness of the gas barrier film packaging material, the diameter of the winding core used for winding, and the like.

The winding length of the gas barrier film packaging material in the winding step is preferably 1300 m or less.

By adjusting the winding length of the gas barrier film packaging material to be 1300 m or less, water can be suitably supplied up to the center of the gas barrier film packaging material roll. As a result, this configuration is preferable from the viewpoints that, for example, the aging time can be more suitably reduced, and the adhesive strength between the thermal fusion layer 24 and the gas barrier film can be improved.

In consideration of the production efficiency, the manufacturing cost, and the like of the gas barrier film packaging material, the winding length of the gas barrier film packaging material is preferably 900 m or more.

In the manufacturing method according to the embodiment of the present invention, conditions of aging in the aging step are not limited and may be appropriately set depending on the adhesive for forming the adhesive layer 20.

The temperature of aging is preferably 30° C. to 50° C.

The temperature of aging is preferably 30° C. or higher from the viewpoints that, for example, the aging time can be more suitably reduced, and the adhesive strength between the thermal fusion layer 24 and the gas barrier film can be improved.

In addition, the temperature of aging is preferably 50° C. or lower from the viewpoints that, for example, the aging time can be more suitably reduced, and the adhesive strength between the thermal fusion layer 24 and the gas barrier film can be improved.

The temperature of aging is more preferably 35° C. to 45° C. and still more preferably 38° C. to 42° C.

In addition, the time of aging is preferably 48 hours or longer.

The time of aging is preferably 48 hours or longer from the viewpoints that, for example, the aging time can be more suitably reduced, and the adhesive strength between the thermal fusion layer 24 and the gas barrier film can be improved.

The time of aging is more preferably 60 hours or longer and still more preferably 72 hours or longer.

The time of aging may be basically several hours and is preferably 200 hours or shorter in consideration of the productivity, the utilization efficiency of the aging chamber, and the like.

As described above, in the manufacturing method according to the embodiment of the present invention, the thickness of the support 12 is preferably 50 to 125 μm.

The support 12 formed of a PET film or the like has low gas barrier properties. Therefore, an end part acts as a permeation portion of water, and also acts as a movement path of water. Therefore, by adjusting the thickness of the support 12 to be 50 μm or more, the action as the permeation path and the movement path of water can be sufficiently exhibited. As a result, this configuration is preferable from the viewpoints that, for example, water can be sufficiently supplied up to the center of the adhesive layer 20 in the width direction, the aging time can be more suitably reduced, and the adhesive strength between the thermal fusion layer 24 and the gas barrier film can be improved.

The thickness of the support 12 is preferably 125 μm or less from the viewpoint of the adhesive layer 20 and the thermal fusion layer 24 can be prevented from being peeled off due to stress during transport or the like.

The thickness of the support 12 is more preferably 75 to 115 μm and still more preferably 95 to 105 μm.

In addition, as described above, in the manufacturing method according to the embodiment of the present invention, the width of the support 12 is preferably 250 to 1000 mm.

As described above, in the manufacturing method according to the embodiment of the present invention, the size of the non-formation region 26 is preferably 3% to 15% of the width of the support. In consideration of this point, by adjusting the width of the support 12 to be 250 mm or more, the size of the non-formation region 26 can be appropriately controlled. Further, the width of the support 12 is preferably 250 mm or more from the viewpoint that, for example, the effective width that can be suitably ensured.

In addition, by adjusting the width of the support 12 to be 1000 mm or less, water permeated into the support 12 can be suitably supplied up to the center in the width direction. Therefore, this configuration is preferable from the viewpoints that, for example, the aging time can be more suitably reduced, and the adhesive strength between the thermal fusion layer 24 and the gas barrier film can be improved.

The width of the support 12 is more preferably 350 to 900 mm and still more preferably 450 to 800 mm.

Further, as described above, in the manufacturing method according to the embodiment of the present invention, the thickness of the thermal fusion layer 24 is preferably 30 to 70 μm.

The thermal fusion layer 24 formed of PE, PP, or the like has low gas barrier properties. Therefore, an end part also acts as a permeation portion of water, and also acts as a movement path of water. Therefore, by adjusting the thickness of the thermal fusion layer 24 to be 30 μm or more, the action of the thermal fusion layer 24 as the permeation path and the movement path of water can be sufficiently exhibited. As a result, this configuration is preferable from the viewpoints that, for example, water can be sufficiently supplied up to the center of the adhesive layer 20 in the width direction, the aging time can be more suitably reduced, and the adhesive strength between the thermal fusion layer 24 and the gas barrier film can be improved.

The thickness of the thermal fusion layer 24 is preferably 70 μm or less from the viewpoints that, for example, the drying of the adhesive after the application can be suitably performed to ensure the adhesive strength with the adhesive layer 20, and the thermal fusion of the gas barrier film packaging material can be improved.

The thickness of the thermal fusion layer 24 is more preferably 40 to 60 μm and still more preferably 45 to 55 μm.

Hereinbefore, the method of manufacturing a gas barrier film packaging material according to the embodiment of the present invention has been described in detail. However, the present invention is not limited to the above-described aspects and various improvements and changes may be made within a range not departing from the scope of the present invention.

### EXAMPLES

Hereinafter, the present invention will be described in detail using Examples. The present invention is not limited to specific examples described below.

### Example 1

### <Support>

A polyethylene terephthalate film (PET film, manufactured by Toyobo Co., Ltd., trade name: A4300, thickness: 100 μm, width: 700 mm) was prepared as the support, and an underlying organic layer, an inorganic layer, and a protective organic layer were formed on a single surface side of the PET film in the following procedure.

### <Formation of Underlying Organic Layer>

TMPTA (manufactured by Daicel-Allnex Ltd.) and a photopolymerization initiator (ESACURE KTO 46, manufactured by Lamberti S.p.A.) were prepared and were weighed such that a weight ratio thereof was 95:5. These components were dissolved in methyl ethyl ketone. As a result, a coating solution (composition for forming an organic layer) having a concentration of solid contents of 15% was obtained.

This coating solution was applied to the above-described PET film through RtoR using a die coater, and the substrate was allowed to pass through a drying zone at 50° C. for 3 minutes. Next, while being heated using a backup roll at 80° C., the coating film was irradiated and cured with ultraviolet rays (cumulative irradiation amount: about 600 mJ/cm²), and the laminate was wound. Before contact with an initial film surface touch roll after the UV curing, a polyethylene protective film was bonded, and then the laminate was wound. The thickness of the underlying organic layer formed on the PET film was 2 μm.

The underlying organic layer was formed in a center region of 640 mm in the width direction of the PET film. That is, the underlying organic layer was not formed in both end parts of 30 mm in the width direction of the PET film.

### <Formation of Inorganic Layer>

Using a RtoR CVD device, a silicon nitride film was formed as the inorganic layer on the underlying organic layer.

Specifically, the wound PET film with the underlying organic layer was fed, the protective film was peeled after passing through a final film surface touch roll before film formation, and the inorganic film was formed on the exposed resin underlying organic layer.

For the formation of the inorganic film, silane gas (flow rate: 160 sccm), ammonia gas (flow rate: 370 sccm), hydrogen gas (flow rate: 590 sccm), and nitrogen gas (flow rate: 240 sccm) were used as raw material gas. As a power supply, a silicon nitride film was formed using a high frequency power supply having a frequency of 13.56 MHZ. Before contact with an initial film surface touch roll after the formation of the inorganic layer, a polyethylene protective film was bonded, and then the laminate was wound. The film formation pressure was 40 Pa, and the peak film thickness was 30 nm.

The inorganic layer was formed on the entire surface in the width direction of the PET film.

### <Formation of Protective Organic Layer>

A protective organic layer was formed on the surface of the inorganic layer.

As a coating liquid for forming the protective organic layer, a urethane skeleton acrylate polymer (ACRIT 8BR930, manufactured by Taisei Fine Chemical Co., Ltd.), an additive (VYLON U1510, manufactured by Toyobo Co., Ltd.), and a silane coupling agent (KBM5103, manufactured by Shin-Etsu Silicone Co., Ltd.) were mixed at a ratio of 73.25% to 15% to 10%, 1.75% of a photopolymerization initiator (ESCURE KTO46, manufactured by Lamberti S.p.A.) was added, and the components were dissolved in methyl ethyl ketone to prepare a coating liquid having a concentration of solid contents of 15%.

This coating liquid was directly applied to the inorganic layer surface through RtoR using a die coater, and was allowed to pass through a drying zone at 100° C. for 3 minutes. Next, while being wound around a heat roll heated to 60° C., the coating film was irradiated and cured with ultraviolet rays (cumulative irradiation amount: about 600 mJ/cm²) to form a protective organic layer, and a gas barrier film was prepared and wound.

The thickness of the protective organic layer formed on the inorganic layer was 1 μm.

The underlying organic layer was formed in a center region of 640 mm in the width direction of the PET film. That is, the underlying organic layer was not formed in both end parts of 30 mm in the width direction of the PET film.

Accordingly, in the present example, the region of 30 mm of both end parts in the width direction of the gas barrier film was the non-formation region.

### <Bonding of Thermal Fusion Layer and Winding of Gas Barrier Film Packaging Material>

Through RtoR, an adhesive was applied to the surface of the gas barrier film to cover the entire surface of the support and was dried to form an adhesive layer. Next, the thermal fusion layer was laminated on the adhesive layer to prepare a gas barrier film packaging material, and the prepared gas barrier film packaging material was wound.

As the adhesive, a polyurethane adhesive (main agent: polyester polyol; RU-77T manufactured by Rock Paint Co., Ltd., curing agent: aliphatic isocyanate; H-7, manufactured by Rock Paint Co., Ltd.) was used. The thickness of the adhesive layer was set to 3 μm.

As the thermal fusion layer, a PE film (polyethylene film, manufactured by TORAY INDUSTRIES, INC., melting point: about 161° C.) having a thickness of 30 μm and a width of 700 mm was used.

The tension of winding of the prepared gas barrier film packaging material was 30 N. In addition, the winding length was 1000 m. As the winding core, a core having a diameter of 6 inches was used.

### <Aging>

The wound gas barrier film packaging material was accommodated in the aging chamber, and the gas barrier film packaging material was aged to manufacture the aged gas barrier film packaging material.

The temperature of the aging chamber was 40° C. The time of aging was 72 hours (h).

### Example 2

An aged gas barrier film packaging material was manufactured using the same method as that of Example 1, except that the formation of the underlying organic layer and the protective organic layer was performed in a center region of 670 mm in the width direction of the support during the preparation of the gas barrier film.

That is, in the present example, the region of 15 mm of both end parts in the width direction of the gas barrier film was the non-formation region.

### Example 3

An aged gas barrier film packaging material was manufactured using the same method as that of Example 1, except that the formation of the underlying organic layer and the protective organic layer was performed in a center region of 600 mm in the width direction of the support during the preparation of the gas barrier film.

That is, in the present example, the region of 50 mm of both end parts in the width direction of the gas barrier film was the non-formation region.

### Example 4

An aged gas barrier film packaging material was manufactured using the same method as that of Example 1, except that the aging time was 40 hours.

### Example 5

An aged gas barrier film packaging material was manufactured using the same method as that of Example 1, except that the temperature of the aging chamber was 25° C.

### Example 6

An aged gas barrier film packaging material was manufactured using the same method as that of Example 1, except that the temperature of the aging chamber was 55° C.

### Comparative Example 1

An aged gas barrier film packaging material was manufactured using the same method as that of Example 1, except that the formation of the underlying organic layer and the protective organic layer was performed on the entire surface in the entire surface in the width direction of the support during the preparation of the gas barrier film, and the aging time was 200 hours.

That is, in the present example, the non-formation region was not provided in both end parts in the width direction of the gas barrier film.

### [Gas Barrier Performance]

In the manufactured gas barrier film packaging material, after preparing the gas barrier film, the water vapor transmission rate in the center portion in the width direction of the gas barrier film and the water vapor transmission rate in the non-formation region where the underlying organic layer and the protective organic layer were not formed in the end parts in the width direction were measured.

The measurement of the water vapor transmission rate was performed using a calcium corrosion method (method described in JP2005-283561A) under conditions of a temperature of 25° C. and a relative humidity of 50%.

As a result, in all of the gas barrier films, the water vapor transmission rate of the center portion in the width direction was 1.0×10⁻⁴ g/(m²·day) or less, and the water vapor transmission rate of the non-formation region was 1.0×10⁻¹ g/(m²·day) or more. In Comparative Example 1, the non-formation region was not provided. Therefore, only the water vapor transmission rate of the center portion in the width direction was measured.

In the manufactured gas barrier film packaging material, the measurement result of the water vapor transmission rate was the same.

### [Adhesive Strength of Thermal Fusion Layer]

A peel strength of the thermal fusion layer was measured using a 180° peel test of JIS Z 0237:2009.

Regarding the measurement of the peel strength, the prepared gas barrier film packaging material was cut into a strip shape of 25×50 mm parallel to the width direction (25 mm) and the longitudinal direction at a position of 10 m from the application start position of the adhesive on the winding core side (roll inside) and at an intersection of diagonal lines of a strip that was the center portion in the width direction. As a result, the thermal fusion layer at an end part of 5 mm in the longitudinal direction was peeled off to obtain a sample.

The evaluation was performed according to the following standards.
A: the peel strength was 8 N/25 mm or more.
B: the peel strength was 6 N/25 mm or more and less than 8 N/25 mm.
C: the peel strength was 4 N/25 mm or more and less than 6 N/25 mm.
D: the peel strength was 2 N/25 mm or more and less than 4 N/25 mm.
E: the peel strength was less than 2 N/25 mm.

In a case where the evaluation result is C or more, the adhesive strength of the thermal fusion layer was sufficient in practice.

The results are shown in the following table.

TABLE 1

| | | | Gas Barrier Layer | | | | | | | | | Adhesive | |
|---|---|---|---|---|---|---|---|---|---|---|---|---|---|
| | | | Width of | | Width of | | | | | | | Strength | |
| | Support | | Underlying | Width of | Protective | Thermal | | Winding | | Aging | | Peel | |
| | | Thick- | Organic | Inorganic | Organic | Fusion Layer | | | Winding | Temper- | | Test | |
| | Width | ness | Layer | Layer | Layer | Forming | Width | Tension | Length | ature | Time | [N/25 | Deter- |
| | [mm] | [μm] | [mm] | [mm] | [mm] | Material | [mm] | [N] | [m] | [° C.] | [h] | mm] | mination |
| Example 1 | 700 | 100 | 640 | 700 | 640 | PE | 700 | 30 | 1000 | 40 | 72 | 8.2 | A |
| Example 2 | 700 | 100 | 670 | 700 | 670 | PE | 700 | 30 | 1000 | 40 | 72 | 7.5 | B |
| Example 3 | 700 | 100 | 600 | 700 | 600 | PE | 700 | 30 | 1000 | 40 | 72 | 8.9 | A |
| Example 4 | 700 | 100 | 640 | 700 | 640 | PE | 700 | 30 | 1000 | 40 | 40 | 6.3 | B |
| Example 5 | 700 | 100 | 640 | 700 | 640 | PE | 700 | 30 | 1000 | 25 | 72 | 5.7 | C |
| Example 6 | 700 | 100 | 640 | 700 | 640 | PE | 700 | 30 | 1000 | 55 | 72 | 7.1 | B |
| Compar- | 700 | 100 | 700 | 700 | 700 | PE | 700 | 30 | 1000 | 40 | 200 | 1.9 | E |
| ative | | | | | | | | | | | | | |
| Example 1 | | | | | | | | | | | | | |

As can be seen from Table 1, in the gas barrier film packaging material according to the embodiment of the present invention where the non-formation region was provided in the non-formation region in both ends in the width direction of the gas barrier film, in a case where the aging time was 72 hours or 40 hours, the adhesive strength of the thermal fusion layer was sufficient.

On the other hand, in the gas barrier film packaging material according to Comparative Example 1 where the gas barrier film did not include the non-formation region, even in a case where aging was performed for 200 hours, a sufficient adhesive strength of the thermal fusion layer was not obtained.

In addition, as shown in Example 1 and Examples 4 to 6, by performing aging in a temperature range of 30° C. to 55° C. for 48 hours or longer, a higher adhesive strength of the thermal fusion layer was obtained.

From the above results, the effects of the present invention are obvious.

### EXPLANATION OF REFERENCES

10, 10P: gas barrier film packaging material
12, 12a, 12b: support
12R, 12aR, 12bR: support roll
14: underlying organic layer
16: inorganic layer
18: protective organic layer
20: adhesive layer
24: thermal fusion layer
26: non-formation region
40: organic film forming device
42: application unit
46, 46a, 46b: drying unit
48: light irradiation unit
50, 92: rotating shaft
52, 108: winding shaft
60: inorganic film forming device
62: partition wall
64: supply/winding chamber
68: film formation chamber
70: drum
72: vacuum chamber
74, 76: evacuation unit
94a to 94c, 106a to 106c pass roller
96: roll
100A: first film forming unit
100B: second film forming unit
102: drum
114: shower electrode
116: high frequency power supply
118: gas supply unit
F: protective film
FR: protective film roll

What is claimed is:

1. A method of manufacturing a gas barrier film packaging material, comprising:
a gas barrier film preparation step of forming, on a support, a gas barrier layer where one or more laminated structures of an underlying organic layer and an inorganic layer are provided and an upper most layer is a protective organic layer to prepare a gas barrier film;
a bonding step of applying an adhesive to the gas barrier layer of the gas barrier film to cover an entire surface of the support, drying the adhesive, and bonding a thermal fusion layer having a width more than or equal to a width of the support to the adhesive to obtain a gas barrier film packaging material;
a winding step of winding the gas barrier film packaging material; and
an aging step of heating and aging the wound gas barrier film packaging material,
wherein in the gas barrier film preparation step, a non-formation region where the laminated structure of the underlying organic layer and the inorganic layer and the protective organic layer are not formed is provided in both end parts in a width direction of the support.

2. The method of manufacturing a gas barrier film packaging material according to claim 1,
wherein in the gas barrier film preparation step, the inorganic layer is formed in the non-formation region.

3. The method of manufacturing a gas barrier film packaging material according to claim 1,
wherein in the aging step, a heating temperature is 30° C. to 50° C., and an aging time is 48 hours or longer.

4. The method of manufacturing a gas barrier film packaging material according to claim 1,
wherein a winding tension of the gas barrier film packaging material in the winding step is 10 to 200 N.

5. The method of manufacturing a gas barrier film packaging material according to claim 1,
wherein in the gas barrier film, a gas barrier performance in the non-formation region is lower than a gas barrier performance in a center portion in the width direction of the support.

6. The method of manufacturing a gas barrier film packaging material according to claim 5,
wherein a water vapor transmission rate in the center portion of the gas barrier film in the width direction of the support is 1.0×10⁻⁴ g/(m²·day) or less in an environment of a temperature of 25° C. and a relative humidity of 50%, and
a water vapor transmission rate in the non-formation region of the gas barrier film is 1.0×10⁻¹ g/(m²·day) or more in the environment of a temperature of 25° C. and a relative humidity of 50%.

7. The method of manufacturing a gas barrier film packaging material according to claim 1,
wherein in a gas barrier film packaging material to be manufactured, a gas barrier performance in a region corresponding to the non-formation region of the gas barrier film is lower than a gas barrier performance in a region corresponding to a center portion of the gas barrier film in the width direction of the support.

8. The method of manufacturing a gas barrier film packaging material according to claim 7,
wherein in the gas barrier film packaging material to be manufactured, a water vapor transmission rate at a position corresponding to the center portion of the gas barrier film in the width direction of the support is 1.0×10⁻⁴ g/(m²·day) or less in an environment of a temperature of 25° C. and a relative humidity of 50%, and
a water vapor transmission rate in a region corresponding to the non-formation region of the gas barrier film is 1.0×10⁻¹ g/(m²·day) or more in the environment of a temperature of 25° C. and a relative humidity of 50%.

9. The method of manufacturing a gas barrier film packaging material according to claim 1,
wherein the thermal fusion layer is formed of polyethylene or polypropylene.

10. The method of manufacturing a gas barrier film packaging material according to claim 1,
wherein a thickness of the thermal fusion layer is 30 to 70 μm.

11. The method of manufacturing a gas barrier film packaging material according to claim 1,
wherein a thickness of the support is 50 to 125 μm.

12. The method of manufacturing a gas barrier film packaging material according to claim 1,
wherein the width of the support is 250 to 1000 mm.

13. The method of manufacturing a gas barrier film packaging material according to claim 1,
wherein a winding length of the gas barrier film packaging material in the winding step is 1300 m or less.

14. The method of manufacturing a gas barrier film packaging material according to claim 1,
wherein the adhesive is a two-liquid curable adhesive.

15. The method of manufacturing a gas barrier film packaging material according to claim 14,
wherein the adhesive is a two-liquid curable urethane adhesive.

16. The method of manufacturing a gas barrier film packaging material according to claim 2,
wherein in the aging step, a heating temperature is 30° C. to 50° C., and an aging time is 48 hours or longer.

17. The method of manufacturing a gas barrier film packaging material according to claim 2,
wherein a winding tension of the gas barrier film packaging material in the winding step is 10 to 200 N.

18. The method of manufacturing a gas barrier film packaging material according to claim 2,
wherein in the gas barrier film, a gas barrier performance in the non-formation region is lower than a gas barrier performance in a center portion in the width direction of the support.

19. The method of manufacturing a gas barrier film packaging material according to claim 18,
wherein a water vapor transmission rate in the center portion of the gas barrier film in the width direction of the support is 1.0×10⁻⁴ g/(m²·day) or less in an environment of a temperature of 25° C. and a relative humidity of 50%, and
a water vapor transmission rate in the non-formation region of the gas barrier film is 1.0×10⁻¹ g/(m²·day) or more in the environment of a temperature of 25° C. and a relative humidity of 50%.

20. The method of manufacturing a gas barrier film packaging material according to claim 2,
wherein in a gas barrier film packaging material to be manufactured, a gas barrier performance in a region corresponding to the non-formation region of the gas barrier film is lower than a gas barrier performance in a region corresponding to a center portion of the gas barrier film in the width direction of the support.
